(19) United States
(12) Patent Application Publication
(10) Pub. No.: US 2015/0317684 A1
(43) Pub. Date: Nov. 5, 2015

(54) ACOUSTIC TAGS, RELATED COMPUTING DEVICES/SYSTEMS, AND METHODS OF USE THEREOF

(71) Applicants: Digisense Ltd., Petach Tikva (IL); Expro3, LLC, Coral Gables, FL (US)

(72) Inventor: Eyall Abir, Petach Tikva (IL)

(21) Appl. No.: 14/704,443

(22) Filed: May 5, 2015

Related U.S. Application Data
(60) Provisional application No. 61/988,486, filed on May 5, 2014.

(51) Int. Cl. G06Q 30/02; G06K 7/02

(52) U.S. Cl. CPC G06Q 30/0267; G06K 7/02

(57) ABSTRACT

A method for mobile advertising, comprising transmitting, by an acoustic tag, a pre-determined acoustic signal associated with the acoustic tag, using a first software program executed on the acoustic tag, initiating, by a handheld electronic device, a monitoring of ambient sound for the emitted acoustic signal associated with the acoustic tag, determining, in the ambient sound, a particular acoustic signal associated with a particular acoustic tag; and presenting at least one advertisement message.

### CROSS REFERENCE TO RELATED APPLICATIONS

This application claims priority to U.S. Provisional Patent Application No. 61/988,486, filed May 5, 2014, the contents of which is hereby incorporated by reference in its entirety.

### FIELD OF THE INVENTION

The invention relates to the field of sales promotion.

### BACKGROUND

In-store advertising and sales promotion are highly-diverse fields. Store and brand owners use an ever-growing variety of means to attract the attention of shoppers to different products, brands and promotions. Many such means are visual in nature, and include placement of products in visible locations in a store (such as at eye level), at the ends of aisles and near checkout counters; eye-catching promotional displays; and advertisements in such places as shopping carts and in-store video displays.

In recent years, attempts have been made to utilize the handheld electronic devices of the shoppers, such as their smart phones, for displaying advertisements as the shoppers approach a store, a shopping mall, etc. One of the earlier attempts was Bluetooth advertising. A Bluetooth transmitter (or “hotspot”) is positioned at or near a shopping location, continuously searching for nearby Bluetooth-enabled devices. When a device is found, an advertisement is transmitted to it by the transmitter. Since the operational range of Bluetooth usually stretches to only a few dozen meters, this technique warrants that the shoppers who receive the advertisements are located close enough to be able to enter the store and complete a purchase.

As smart phones and other sophisticated handheld electronic devices become more and more abundant, advertisers continuously search for new ways to harness this phenomenon to their advantage. A new field of “mobile advertising” sprouted, introducing advertising using SMS (short message service), MMS (multimedia message service), push notifications, scanning of QR (quick response) codes and more. Since many new devices include location modules (such as GPSs), it has been made possible to target mobile advertisements to shoppers located at or near certain stores or other shopping locations.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

One embodiment provides method is for mobile advertising, comprising: transmitting, by an acoustic tag, a pre-determined acoustic signal associated with the acoustic tag, using a first software program executed on the acoustic tag, wherein the first software program is stored in a first non-transitory computer-readable storage medium of the acoustic tag, wherein the acoustic tag has a first hardware processor that executes the first software program, and wherein the first hardware processor, when executing the first software program, emits the acoustic signal associated with the acoustic tag through an acoustic transducer, initiating, by a handheld electronic device, a monitoring of ambient sound for the emitted acoustic signal associated with the acoustic tag, using a second software program executed on the handheld electronic device, wherein the second software program is stored in a second non-transitory computer-readable storage medium of the handheld electronic device, and wherein the ambient sound is acquired via a microphone on the handheld electronic device, and converted to an electrical signal that corresponds to the ambient sound acquired by the microphone, transmitting the electrical signal that corresponds to the ambient sound to a second hardware processor specifically programmed to analyze the electrical signal that corresponds to the ambient sound for the presence of the emitted specific acoustic signal associated with the acoustic tag, wherein the second hardware processor executes a third software program being stored in a third non-transitory computer-readable storage medium, and wherein the second hardware processor, when executing the third software program, performs at least the following steps: 1. converting the electrical signal that corresponds to the ambient sound from a time-domain type signal to a frequency-domain type signal based at least in part, on at least one fast Fourier transform (FFT) algorithm; 2. comparing the resulting frequency-domain type signal to a plurality of entries in at least one lookup table wherein each entry corresponds to at least one acoustic signal associated with at least one acoustic tag; 3. based on the comparing, determining, in the ambient sound, a particular acoustic signal associated with a particular acoustic tag; and 4. based on the determining, transmitting at least one notification confirming the presence of the particular acoustic tag; and based on the at least one notification, triggering, by the handheld electronic device, presenting at least one advertisement message, wherein the at least one advertisement message is specifically pre-determined for the presence of the particular acoustic signal associated with the particular acoustic tag.

In some embodiments, the method further comprises presenting the at least one advertisement message on a display of the handheld electronic device.

In some embodiments, the method further comprises initiating the monitoring of ambient sound when the handheld electronic device is in a pre-determined location.

In some embodiments, the method further comprises initiating the monitoring of ambient sound when the handheld electronic device when the handheld electronic device is in proximity to the particular acoustic tag.

In some embodiments, the method further comprises the handheld device further comprising a location module is selected from the group consisting of: a global positioning system (GPS) hardware module, a cellular multilateration software module and a Wi-Fi-based positioning system (WPS) software module.

In some embodiments, the method further comprises the at least one advertisement message associated with the acoustic tag being stored on a server containing a plurality of advertisement messages. In some embodiments, the triggering by the handheld device includes communicating with the server to retrieve the at least one advertisement message associated with the acoustic tag from the plurality of advertisement messages.

In some embodiments, the method further comprises the pre-determined acoustic signal being encoded and executed by an oscillator chip.

One embodiment provides a computing advertisement system, comprising: a first software program is stored in a first non-transitory computer-readable storage medium, a first hardware processor, when executing the first software program, is configured to at least perform: 1. receiving the electrical signal that corresponds to an ambient sound; 2. converting the electrical signal that corresponds to the ambient sound from a time-domain type signal to a frequency-domain type signal based at least in part, on at least one fast Fourier transform (FFT) algorithm; 3. comparing the resulting frequency-domain type signal to a plurality of entries in at least one lookup table wherein each entry corresponds to at least one acoustic signal associated with at least one acoustic tag; 4. based on the comparing, determining, in the ambient sound, a particular acoustic signal associated with a particular acoustic tag; 5. based on the determining, transmitting at least one notification confirming the presence of the particular acoustic tag; 6. based on the at least one notification, causing to trigger, by a handheld electronic device, presenting at least one advertisement message, wherein the at least one advertisement message is specifically pre-determined for the presence of the particular acoustic signal associated with the particular acoustic tag; wherein the electrical signal is generated, by a handheld electronic device, when the handheld electronic device: monitors the ambient sound for an emitted acoustic signal associated with an acoustic tag, using a second software program executed on the handheld electronic device, wherein the second software program is stored in a second non-transitory computer-readable storage medium of the handheld electronic device, and acquires the ambient sound via a microphone on the handheld electronic device; and wherein the emitted acoustic signal is emitted by an acoustic tag, comprising: a third software program is stored in a third non-transitory computer-readable storage medium, a third hardware processor, when executing the third software program, is configured to at least perform: transmit a trigger signal; an acoustic transducer that emits an acoustic signal that is associated with the acoustic tag, when the trigger signal is received, and a power supply.

In some embodiments, the computing advertising system further comprises the power supply is configured to power-down the acoustic tag under certain conditions.

In some embodiments, the computing advertising system further comprises the acoustic tag configured to be attached to an object.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1 shows a block diagram of a promotional acoustic tag.

FIG. 2 shows a network diagram of a promotional system.

FIG. 3 shows a semi-pictorial illustration of an exemplary shopping environment.

FIG. 4 shows a block diagram of a portable multifunction device.

FIG. 5 shows a diagram of an oscillator circuit according to certain embodiments of the invention.

FIG. 6 shows a diagram of an oscillator circuit according to certain embodiments of the invention.

FIG. 7 shows a diagram of an oscillator circuit according to certain embodiments of the invention.

FIG. 8 shows a diagram of an oscillator circuit according to certain embodiments of the invention.

FIG. 9 shows a block diagram of an embodiment of the present invention.

### DETAILED DESCRIPTION

Disclosed herein is a promotional acoustic tag, a promotional system and methods for their operation. The promotional acoustic tag may be positioned, for example, inside or outside a store, at an acoustically-efficient range from portable multifunction devices (e.g. smart phones) of shoppers passing by. For example, it may be attached to a product package, to a store shelve, to a products stand, to a wall of the store, etc. The acoustic tag may transmit a message, encoded acoustically, to one or more such portable multifunction devices. Upon receipt of the message, a receiving portable multifunction device may decode the message and trigger the presentation of an advertisement on the portable multifunction device. The advertisement may be fetched by the portable multifunction device from a server of the promotional system. The advertisement may be related to the product to which the promotional acoustic tag is attached and/or to any other promotional subject matter.

One embodiment provides a method for mobile advertising, comprising: providing an acoustic tag comprising an acoustic transducer and a microcontroller, wherein said microcontroller is preprogrammed with an advertisement triggering message; and feeding said microcontroller with a voltage of a predefined range, thereby exciting said acoustic transducer so as to encode the advertisement triggering message in an acoustic signal.

In some embodiments, the method further comprises, in a handheld electronic device: receiving the acoustic signal; decoding the acoustic signal, to output the advertisement triggering message; and presenting an advertisement based on the advertisement triggering message.

In some embodiments, said decoding is performed by a processor of said handheld electronic device, and said presenting is on a display of said handheld electronic device.

In some embodiments, said receiving of the acoustic signal comprises, in a processor of said handheld electronic device: receiving an electrical signal from a microphone of said handheld electronic device; converting the electrical signal into a digital signal; detecting the acoustic signal in the digital signal, based on a predefined protocol stored in a non-volatile memory of said handheld electronic device.

In some embodiments, said detecting comprises applying a fast Fourier transform (FFT) algorithm to the digital signal.

In some embodiments, the method further comprises, in the handheld electronic device, initiating a listening to ambient sound, responsive to a location module of the handheld electronic device indicating that the handheld electronic device is in proximity to said acoustic tag.

In some embodiments, said location module comprises at least one module selected from the group consisting of: a global positioning system (GPS) hardware module, a cellular multilateration software module and a Wi-Fi-based positioning system (WPS) software module.

In some embodiments, the method further comprises conserving power in said acoustic tag by ceasing said feeding of the voltage responsive to a photodetector reading.

Another embodiment provides a promotional system comprising: an acoustic tag configured to be attached to an object, said acoustic tag comprising an acoustic transducer and a microcontroller, wherein said microcontroller is configured, responsive to being fed with a voltage of a predefined range, to excite said acoustic transducer so as to synthesize an acoustic signal according to a predefined protocol; and a promotion server comprising a non-volatile memory having stored therein a plurality of advertisements.

In some embodiments, the promotional system further comprises a handheld electronic device comprising a microphone, a display and a processor configured to: receive an electrical signal from said microphone; detect, based on the predefined protocol, the acoustic signal in the electrical signal; decode the acoustic signal; based on the decoded acoustic signal, fetch an advertisement of the plurality of advertisements from said promotion server; and present the advertisement on said display.

One embodiment provides method is for mobile advertising, comprising: transmitting, by an acoustic tag, a pre-determined acoustic signal associated with the acoustic tag, using a first software program executed on the acoustic tag, wherein the first software program is stored in a first non-transitory computer-readable storage medium of the acoustic tag, wherein the acoustic tag has a first hardware processor that executes the first software program, and wherein the first hardware processor, when executing the first software program, emits the acoustic signal associated with the acoustic tag through an acoustic transducer, initiating, by a handheld electronic device, a monitoring of ambient sound for the emitted acoustic signal associated with the acoustic tag, using a second software program executed on the handheld electronic device, wherein the second software program is stored in a second non-transitory computer-readable storage medium of the handheld electronic device, and wherein the ambient sound is acquired via a microphone on the handheld electronic device, and converted to an electrical signal that corresponds to the ambient sound acquired by the microphone, transmitting the electrical signal that corresponds to the ambient sound to a second hardware processor specifically programmed to analyze the electrical signal that corresponds to the ambient sound for the presence of the emitted specific acoustic signal associated with the acoustic tag, wherein the second hardware processor executes a third software program being stored in a third non-transitory computer-readable storage medium, and wherein the second hardware processor, when executing the third software program, performs at least the following steps: 1. converting the electrical signal that corresponds to the ambient sound from a time-domain type signal to a frequency-domain type signal based at least in part, on at least one fast Fourier transform (FFT) algorithm; 2. comparing the resulting frequency-domain type signal to a plurality of entries in at least one lookup table wherein each entry corresponds to at least one acoustic signal associated with at least one acoustic tag; 3. based on the comparing, determining, in the ambient sound, a particular acoustic signal associated with a particular acoustic tag; and 4. based on the determining, transmitting at least one notification confirming the presence of the particular acoustic tag; and based on the at least one notification, triggering, by the handheld electronic device, presenting at least one advertisement message, wherein the at least one advertisement message is specifically pre-determined for the presence of the particular acoustic signal associated with the particular acoustic tag.

In some embodiments, the method further comprises presenting the at least one advertisement message on a display of the handheld electronic device.

In some embodiments, the method further comprises initiating the monitoring of ambient sound when the handheld electronic device is in a pre-determined location.

In some embodiments, the method further comprises initiating the monitoring of ambient sound when the handheld electronic device when the handheld electronic device is in proximity to the particular acoustic tag.

In some embodiments, the method further comprises the handheld device further comprising a location module is selected from the group consisting of: a global positioning system (GPS) hardware module, a cellular multilateration software module and a Wi-Fi-based positioning system (WPS) software module.

In some embodiments, the method further comprises the at least one advertisement message associated with the acoustic tag being stored on a server containing a plurality of advertisement messages. In some embodiments, the triggering by the handheld device includes communicating with the server to retrieve the at least one advertisement message associated with the acoustic tag from the plurality of advertisement messages.

In some embodiments, the method further comprises the pre-determined acoustic signal being encoded and executed by an oscillator chip.

One embodiment provides a computing advertisement system, comprising: a first software program is stored in a first non-transitory computer-readable storage medium, a first hardware processor, when executing the first software program, is configured to at least perform: 1. receiving the electrical signal that corresponds to an ambient sound; 2. converting the electrical signal that corresponds to the ambient sound from a time-domain type signal to a frequency-domain type signal based at least in part, on at least one fast Fourier transform (FFT) algorithm; 3. comparing the resulting frequency-domain type signal to a plurality of entries in at least one lookup table wherein each entry corresponds to at least one acoustic signal associated with at least one acoustic tag; 4. based on the comparing, determining, in the ambient sound, a particular acoustic signal associated with a particular acoustic tag; 5. based on the determining, transmitting at least one notification confirming the presence of the particular acoustic tag; 6. based on the at least one notification, causing to trigger, by a handheld electronic device, presenting at least one advertisement message, wherein the at least one advertisement message is specifically pre-determined for the presence of the particular acoustic signal associated with the particular acoustic tag; wherein the electrical signal is generated, by a handheld electronic device, when the handheld electronic device: monitors the ambient sound for an emitted acoustic signal associated with an acoustic tag, using a second software program executed on the handheld electronic device, wherein the second software program is stored in a second non-transitory computer-readable storage medium of the handheld electronic device, and acquires the ambient sound via a microphone on the handheld electronic device; and wherein the emitted acoustic signal is emitted by an acoustic tag, comprising: a third software program is stored in a third non-transitory computer-readable storage medium, a third hardware processor, when executing the third software program, is configured to at least perform: transmit a trigger signal; an acoustic transducer that emits an acoustic signal that is associated with the acoustic tag, when the trigger signal is received, and a power supply.

In some embodiments, the computing advertising system further comprises the power supply is configured to power-down the acoustic tag under certain conditions.

In some embodiments, the computing advertising system further comprises the acoustic tag configured to be attached to an object.

In addition to the exemplary aspects and embodiments described above, further aspects and embodiments will become apparent by reference to the figures and by study of the following detailed description.

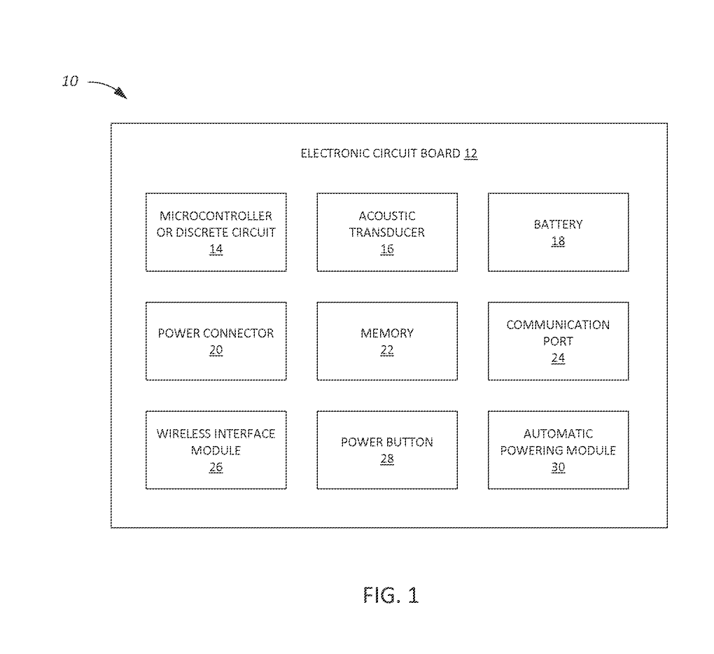

Reference is now made to FIG. 1, which shows a block diagram of a promotional acoustic tag (hereinafter “tag”) 10, in accordance with an embodiment. Tag 10 may include an electronic circuit board 12 having a microcontroller 14 and an acoustic transducer 16, each embedded in or electrically connected to the electronic circuit board. Tag 10 may be packaged in a conveniently small housing, having a volume of, for example, 1-10 cubic centimeters (cc). However, the housing may have a volume lower or higher than this range.

Microcontroller 14, in some embodiments, may be substituted by a discrete circuit including multiple components configured, as a whole, to provide essentially the same functionality as a microcontroller.

Electronic circuit board 12 may further include a battery 18 (or a plurality of batteries), either a disposable or a rechargeable one. Additionally or alternatively, electronic circuit board 12 may include a power connector 20 configured to connect to an external power source, for recharging battery 18 and/or for providing power for the operation of the electronic circuit board.

Microcontroller 14 may be preprogrammed with an advertisement triggering message. Alternatively, electronic circuit board 12 may include a memory 22 external to the microcontroller, which memory may be preprogrammed with an advertisement triggering message. The advertisement triggering message may be any data in compliance with a predefined protocol, which, upon receipt and encoding by a portable multifunction device, may trigger the presentation of an advertisement on the portable multifunction device. This is discussed below in greater detail.

In operation of tag 10, a voltage may be fed from battery 18 or power connector 20 to electronic circuit board 12. The voltage may be within a predefined range, for example within ±20% of 1.5 Volts. Responsive to this voltage, microcontroller 14 may excite acoustic transducer 16 in a manner which encodes (also “synthesizes”) the advertisement triggering message in an acoustic signal emitted by the acoustic transducer. The excitation of acoustic transducer 16 may be based, for example, on pulse-width modulation (PWM), as known in the art. In accordance with PWM principles, microcontroller 14 may rapidly pulse acoustic transducer 16, namely—turn on and off power to the acoustic transducer. The exact sequence of pulses and intermissions therebetween may encode the advertisement triggering message. Generally, the shorter a pulse, the higher the frequency of sound emitted by acoustic transducer 16, and vice versa.

The advertisement triggering message, as discussed above, may be preprogrammed in microcontroller 14 or memory 22, for example in a manufacturing stage. Additionally or alternatively, microcontroller 14 or memory 22 may be preprogrammed with a predefined protocol which includes instructions for encoding, in the microcontroller the memory, an advertisement triggering message provided by a user. This way, a user, such as a store employee, may occasionally change the advertisement triggering message stored in microcontroller 14 or memory 22. The user may provide the advertisement triggering message to tag 10, for example by connecting to it a dedicated programming device or any other computing device, and microcontroller 14 may encode the advertisement triggering message, according to the predefined protocol, in the microcontroller or memory 22.

The connection of the dedicated programming device or the other computing device to tag 10 may be wired or wireless. If wired, then electronic circuit board 12 may include a communication port 24 for plugging in a cable extending between the tag and the dedicated programming device or the other computing device. If wireless, then electronic circuit board 12 may include a wireless interface module 26, such as an NFC (near-field communication) module, a BlueTooth module, a WiFi (wireless fidelity) module, etc.

Electronic circuit board 12 may further include a power button 28, for allowing a user to turn tag 10 on and off as necessary, in order, for example, to conserve power in battery 18. Additionally or alternatively, electronic circuit board 12 may include an automatic powering module 30, configured to provide voltage to microcontroller 14 only upon the detection of a certain external stimulus. For example, automatic powering module 30 may include a photodetector, which closes a circuit (thereby providing voltage to microcontroller 14) when light above a predefined threshold is detected, and opens the circuit (thereby ceasing voltage to the microcontroller) when the light falls below the threshold. This way, tag 10 may be active as long as light is on in the store or in the tag's surroundings, and become inactive when light is off—namely, when the store is closed (e.g. during the night).

As another example, automatic powering module 30 may include the acoustic transducer 16 or a different acoustic transducer listening to ambient noise; when noise is above a predefined threshold, a circuit may close. When noise is below that threshold, the circuit may open. A time factor may also be included in this operation, such that the circuit may remain closed for a certain duration after noise above the threshold is detected, e.g. for a few seconds, minutes, hours, etc.

Further examples include automatic powering module 30 being a proximity sensor configured to detect movement next to tag 10, or a radio frequency (RF) receiver configured to provide voltage to microcontroller 14 upon receiving a suitable radio signal from a nearby portable multifunction device of a shopper.

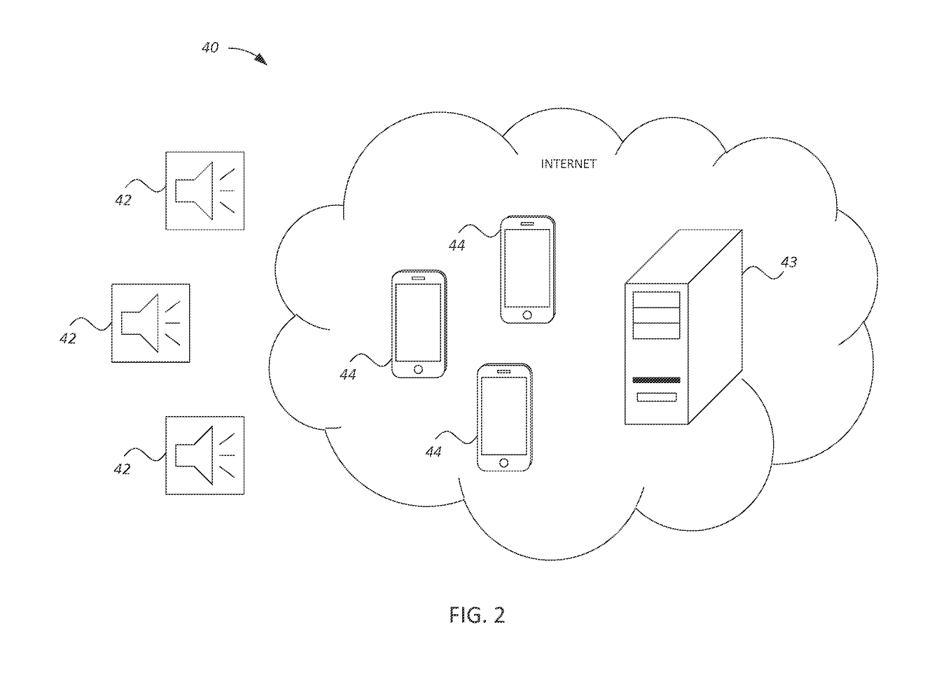

Reference is now made to FIG. 2, which shows a network diagram of a promotional system 40, in accordance with an embodiment. Promotional system 40 may include one or more acoustic tags 42 deployed in one or more stores, shopping malls, etc. Promotional system 40 may further include a promotion server 43 accessible through a wide-area network (WAN) such as the Internet. One or more portable multifunction devices 44 of shoppers may, on one hand, receive one or more acoustic signals from tags 42, and, on the other hand, connect to promotion server 43 for fetching one or more advertisement responsive to the acoustic signals.

In one exemplary configuration of promotional system 40, multiple advertisements may be wholly stored in promotion server 43. Namely, any text, graphics, audio and/or video (jointly referred to as the “creative” of the advertisement) necessary for presenting an advertisement on portable multifunction devices 44 may be stored in promotion server 43.

In another exemplary configuration of promotional system 40, promotion server 43 may serve as an intermediary between portable multifunction devices 44 and one or more different servers (not shown) storing the creative. For example, promotion server 43 may receive requests from portable multifunction devices 44 and refer these devices to fetch the actual creative from the one or more different servers. These servers may be operated, for example, by one or more advertisers.

It should be understood that promotion server 43 may, in practice, be a plurality of physical servers and/or a virtual server running on multiple physical machines simultaneously, in what is known an “cloud computing”.

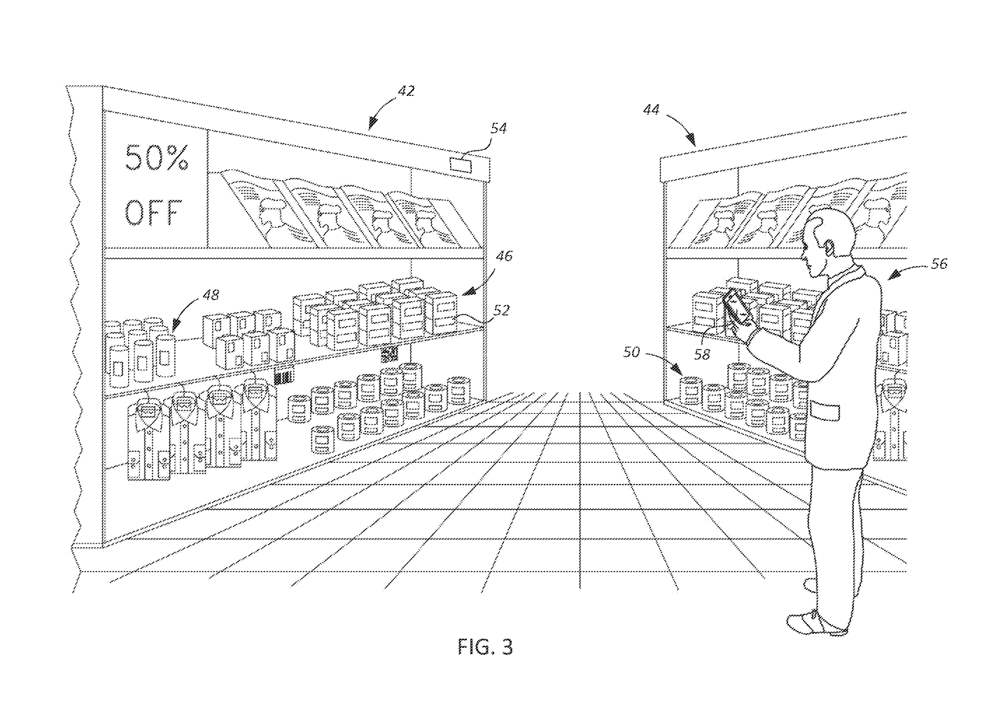

Reference is now made to FIG. 3, which shows a semi-pictorial illustration of an exemplary shopping environment, demonstrating the operation of promotional system 40 (FIG. 2). This exemplary shopping environment is a store having two shelving units 42 and 44 having various products, such as products 46, 48 and 50, arranged therein.

Tags, such as tags 52 and 54 may be attached to a product 46 and to shelving unit 42, respectively. It should be understood that this is merely an example, and tags may be attached to, connected to or integrally formed with any in-store or other element, such as products, product packages, shelves, stands, booths, signs, walls, ceiling, etc.

A shopper 56 equipped with a portable multifunction device 58, such as a personal smart phone of the shopper, may enter the store. Shopper 56 may activate a software application on portable multifunction device 58, which application may be configured to detect acoustic signals using one or more microphones of the portable multifunction device. Alternatively, the software application may be activated automatically upon the shopper 56 entering the store or reaching the whereabouts of the store; for example, a GPS (global positioning system) module of portable multifunction device 58 may launch the software application upon detecting that the portable multifunction device is at a predefined location or area.

Upon portable multifunction device 58 receiving an acoustic signal from one or more of tags 52 and 54, it may decode the acoustic signal and trigger the presentation of an advertising on the portable multifunction device accordingly.

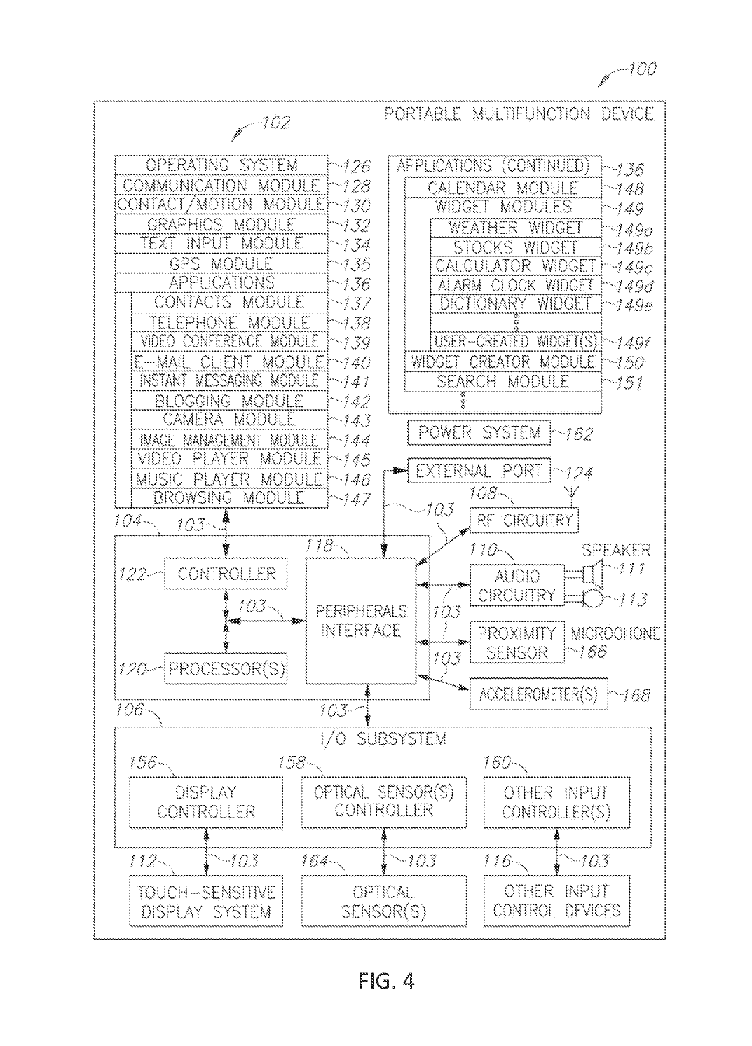

Reference is now made to FIG. 4, which shows a block diagram of a portable multifunction device (also “handheld electronic device” or simply “device”) 100, in accordance with some embodiments.

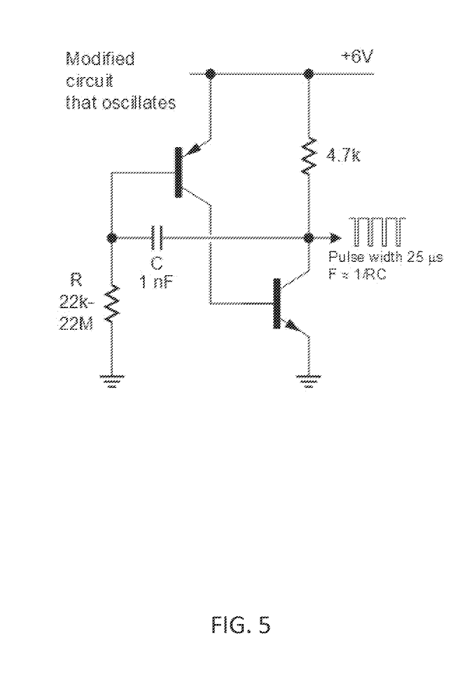

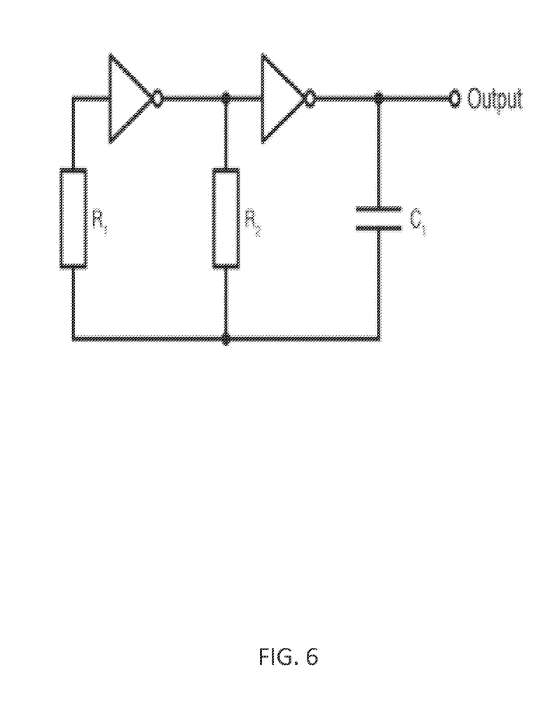

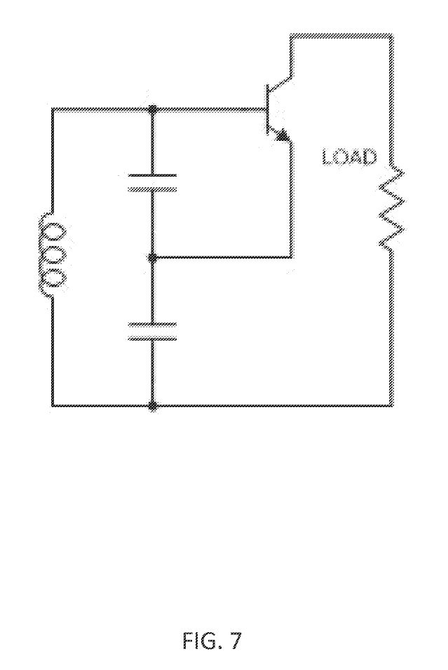

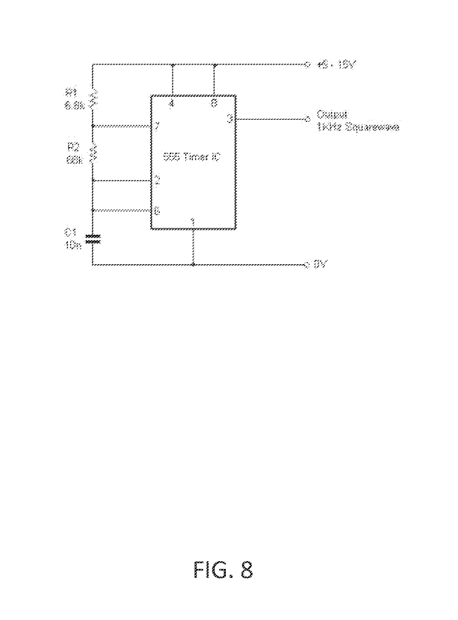

In certain embodiments, microprocessor 14 may be substituted by a discrete circuit including multiple components configured, as a whole, to provide essentially the same functionality as a microcontroller. For instance, in certain embodiments, microprocessor 14 may be substituted by an oscillator chip. Non-limiting examples of oscillator chips are shown in FIGS. 5 to 8. The frequency of the PWM may be determined by selecting the appropriate electronic components to influence the DC duty cycle of the output waveform of the oscillator. For instance, using FIG. 6 as a non-limiting example, the output waveform of the oscillator is determined by the values of one or all of R₁, R₂ or C₁.

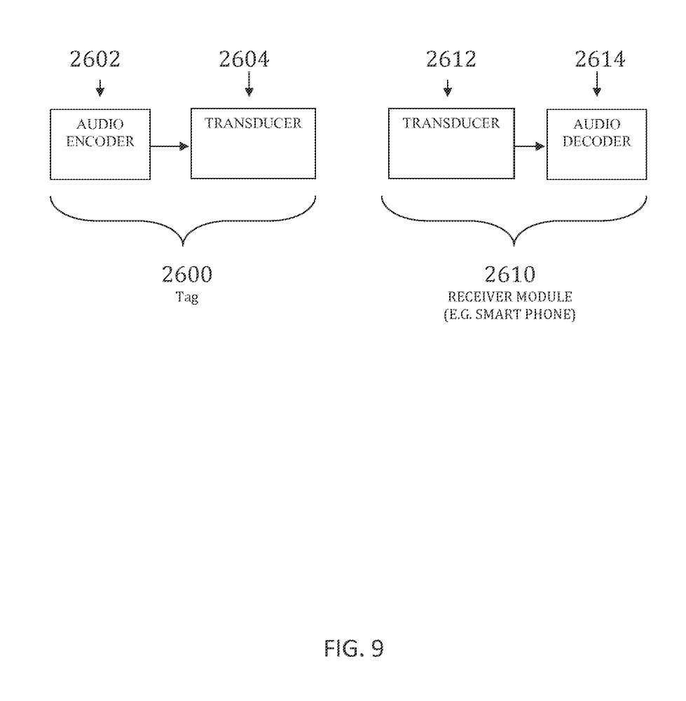

Reference is made to FIG. 9, showing an embodiment. Tag 2600 comprises an audio encoder 2602, which transmits a signal to a transducer 2604. Transducer 2604 transmits an audio signal containing an acoustic signal, which is picked up by the transducer 2612 in receiver module 2610, which transmits the received signal to audio decoder 2614, to decode the audio signal and determine if the acoustic signal is present.

Device 100 may store in a non-volatile memory thereof a software application configured to operate in the framework of promotional system 40 (FIG. 2). The software application may include instructions for receiving an acoustic signal received from a tag, such as tag 10 (FIG. 1), tags 42 (FIG. 2) and/or tags 52 and 54 (FIG. 3). This receiving of the acoustic signal may include operating a processing unit (also “hardware processor”, “CPU” or simply “processor”) of device 100 receive an electrical signal from a microphone of the device, which electrical signal was transduced by the microphone from the acoustic signal and any ambient used captured by the microphone.

The processing unit, or a separate audio circuitry of device 100, may covert the electrical signal from the microphone into a digital signal. Then, the processing unit may detect, in the digital signal, the acoustic signal transmitted by the tag. Namely, the electrical signal and its respective digital signal may include various ambient sounds as well as the acoustic signal whose detection is desired.

The non-volatile memory of device 100 may store thereon a predefined protocol, the same one stored in the tag or the same one according to which the tag encodes the advertising triggering message in the acoustic signal. Alternatively, the predefined protocol may be stored on a server accessible by device 100, such as promotion server 43 (FIG. 2), and the digital signal is transmitted to the server for analysis.

In a simple embodiment, the predefined protocol may include a lookup table of acoustic signals and their interpretation, namely—the advertisement triggering message they each encode. The processing unit of device 100 may analyze the digital signal in real time, and determines whether it includes certain sequences of sounds being the acoustic signals. Alternatively, temporal chunks of the digital signal may be transmitted to the server, which determined whether the digital signal includes certain sequences of sounds being the acoustic signals.

In a more sophisticated embodiment, the predefined protocol may not be limited to a lookup table deterministically limited to a number of advertisement triggering messages. Namely, the processing unit of device 100 or the server may dynamically construct an advertisement triggering message based on the certain sequence found in the digital signal; in this scenario, there is no need to preprogram device 100 or the server in advance with certain advertisement triggering messages.

The processing unit of device 100 or the server optionally employ a suitable algorithm to the digital signal, to aid in detecting the acoustic signal. For example, the processing unit or server may apply a fast Fourier transform (FFT) algorithm to the digital signal. The FFT converts the digital signal, which is a time-domain signal, into a frequency-domain signal. The FFT yields a data series of amplitude (also “power” or “intensity”) as a function of frequency. The FFT may be applied to the digital signal in real time, while the microphone receives ambient sound, such that the data series yielded by the FFT is updated as time progresses. Alternatively, the FFT may be applied separately to each of multiple distinct time portions (e.g. each lasting a few seconds) of the received ambient sound. The FFT may assist in determining which sound frequencies are exhibited in the digital signal.

To conserve power on device 100, which is typically battery-operated, the software application may include a power conservation mechanism. This mechanism may employ the processing unit for listening to ambient sound only upon one or more suitable stimuli are detected. For example, a location module of device 100 may be employed, to trigger the listening when the device is at a location known to have tags, namely—the device is likely to be in such proximity to the tags which may enable it to effectively receive their acoustic signals. The location module may include, for example, a global positioning system (GPS) hardware module, a cellular multilateration software module, a Wi-Fi-based positioning system (WPS) software module, etc.

The advertisement triggering message may encode, for example, a reference to an advertisement creative stored on device 100 itself. As another example, it may encode a reference to an advertisement creative stored on an Internet server. Optionally, the advertisement triggering message may encode a URL (uniform resource locator) of where the advertisement creative is stored, or of an intermediary server configured to refer device 100 to a different location where the creative is stored.

The advertisement creative, as discussed above, may include, text, graphics, audio and/or video. For example, when a tag attached to a diaper package at a drugstore triggers an advertisement in device 100, the device may present the user of the device with an advertising video of the diaper manufacturer. As a further example, the device may present the user with a coupon for purchasing the diapers or any other associated product.

Device 100 may be equipped with a touch-sensitive display 112. The touch-sensitive display 112 is sometimes called a “touch screen” for convenience, and may also be known as or called a touch-sensitive display system. Device 100 may include a memory 102 (which may include one or more computer readable storage mediums), a memory controller 122, one or more processing units (CPUs) 120, a peripherals interface 118, RF circuitry 108, audio circuitry 110, a speaker 111, a microphone 113, an input/output (I/O) subsystem 106, other input or control devices 116, and an external port 124. Device 100 may include one or more optical sensors 164. These components may communicate over one or more communication buses or signal lines 103.

It should be appreciated that device 100 is only one example of a portable multifunction device 100, and that device 100 may have more or fewer components than shown, may combine two or more components, or a may have a different configuration or arrangement of the components. The various components shown in FIG. 4 may be implemented in hardware, software or a combination of both hardware and software, including one or more signal processing and/or application specific integrated circuits.

Memory 102 may include high-speed random access memory and may also include non-volatile memory, such as one or more magnetic disk storage devices, flash memory devices, or other non-volatile solid-state memory devices. Access to memory 102 by other components of device 100, such as the CPU 120 and the peripherals interface 118, may be controlled by the memory controller 122.

The peripherals interface 118 couples the input and output peripherals of the device to the CPU 120 and memory 102. The one or more processors 120 run or execute various software programs and/or sets of instructions stored in memory 102 to perform various functions for device 100 and to process data.

In some embodiments, the peripherals interface 118, the CPU 120, and the memory controller 122 may be implemented on a single chip, such as a chip 104. In some other embodiments, they may be implemented on separate chips.

The RF (radio frequency) circuitry 108 receives and sends RF signals, also called electromagnetic signals. The RF circuitry 108 converts electrical signals to/from electromagnetic signals and communicates with communications networks and other communications devices via the electromagnetic signals. The RF circuitry 108 may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. The RF circuitry 108 may communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), and/or Instant Messaging and Presence Service (IMPS)), and/or Short Message Service (SMS)), or any other suitable communication protocol, including communication protocols not yet developed as of the filing date of this document.

The audio circuitry 110, the speaker 111, and the microphone 113 provide an audio interface between a user and device 100. The audio circuitry 110 receives audio data from the peripherals interface 118, converts the audio data to an electrical signal, and transmits the electrical signal to the speaker 111. The speaker 111 converts the electrical signal to human-audible sound waves. The audio circuitry 110 also receives electrical signals converted by the microphone 113 from sound waves. The audio circuitry 110 converts the electrical signal to audio data and transmits the audio data to the peripherals interface 118 for processing. Audio data may be retrieved from and/or transmitted to memory 102 and/or the RF circuitry 108 by the peripherals interface 118. In some embodiments, the audio circuitry 110 also includes a headset jack. The headset jack provides an interface between the audio circuitry 110 and removable audio input/output peripherals, such as output-only headphones or a headset with both output (e.g., a headphone for one or both ears) and input (e.g., a microphone).

The I/O subsystem 106 couples input/output peripherals on device 100, such as the touch screen 112 and other input/control devices 116, to the peripherals interface 118. The I/O subsystem 106 may include a display controller 156 and one or more input controllers 160 for other input or control devices. The one or more input controllers 160 receive/send electrical signals from/to other input or control devices 116. The other input/control devices 116 may include physical buttons (e.g., push buttons, rocker buttons, etc.), dials, slider switches, joysticks, click wheels, and so forth. In some alternate embodiments, input controller(s) 160 may be coupled to any (or none) of the following: a keyboard, infrared port, USB port, and a pointer device such as a mouse. The one or more buttons may include an up/down button for volume control of the speaker 111 and/or the microphone 113. The one or more buttons may include a push button A quick press of the push button may disengage a lock of the touch screen 112 or begin a process that uses gestures on the touch screen to unlock the device, as described in U.S. patent application Ser. No. 11/322,549, “Unlocking a Device by Performing Gestures on an Unlock Image,” filed Dec. 23, 2005, which is hereby incorporated by reference in its entirety. A longer press of the push button may turn power to device 100 on or off. The user may be able to customize a functionality of one or more of the buttons. The touch screen 112 is used to implement virtual or soft buttons and one or more soft keyboards.

The touch-sensitive touch screen 112 provides an input interface and an output interface between the device and a user. The display controller 156 receives and/or sends electrical signals from/to the touch screen 112. The touch screen 112 displays visual output to the user. The visual output may include graphics, text, icons, video, and any combination thereof (collectively termed “graphics”). In some embodiments, some or all of the visual output may correspond to user-interface objects, further details of which are described below.

A touch screen 112 has a touch-sensitive surface, sensor or set of sensors that accepts input from the user based on haptic and/or tactile contact. The touch screen 112 and the display controller 156 (along with any associated modules and/or sets of instructions in memory 102) detect contact (and any movement or breaking of the contact) on the touch screen 112 and converts the detected contact into interaction with user-interface objects (e.g., one or more soft keys, icons, web pages or images) that are displayed on the touch screen. In an exemplary embodiment, a point of contact between a touch screen 112 and the user corresponds to a finger of the user.

The touch screen 112 may use LCD (liquid crystal display) technology, or LPD (light emitting polymer display) technology, although other display technologies may be used in other embodiments. The touch screen 112 and the display controller 156 may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with a touch screen 112.

A touch-sensitive display in some embodiments of the touch screen 112 may be analogous to the multi-touch sensitive tablets described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in their entirety. However, a touch screen 112 displays visual output from the portable device 100, whereas touch sensitive tablets do not provide visual output.

A touch-sensitive display in some embodiments of the touch screen 112 may be as described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

The touch screen 112 may have a resolution in excess of 100 dpi. In an exemplary embodiment, the touch screen has a resolution of approximately 160 dpi. The user may make contact with the touch screen 112 using any suitable object or appendage, such as a stylus, a finger, and so forth. In some embodiments, the user interface is designed to work primarily with finger-based contacts and gestures, which are much less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 may include a touchpad (not shown) for activating or deactivating particular functions. In some embodiments, the touchpad is a touch-sensitive area of the device that, unlike the touch screen, does not display visual output. The touchpad may be a touch-sensitive surface that is separate from the touch screen 112 or an extension of the touch-sensitive surface formed by the touch screen.

In some embodiments, device 100 may include a physical or virtual click wheel as an input control device 116. A user may navigate among and interact with one or more graphical objects (henceforth referred to as icons) displayed in the touch screen 112 by rotating the click wheel or by moving a point of contact with the click wheel (e.g., where the amount of movement of the point of contact is measured by its angular displacement with respect to a center point of the click wheel). The click wheel may also be used to select one or more of the displayed icons. For example, the user may press down on at least a portion of the click wheel or an associated button. User commands and navigation commands provided by the user via the click wheel may be processed by an input controller 160 as well as one or more of the modules and/or sets of instructions in memory 102. For a virtual click wheel, the click wheel and click wheel controller may be part of the touch screen 112 and the display controller 156, respectively. For a virtual click wheel, the click wheel may be either an opaque or semitransparent object that appears and disappears on the touch screen display in response to user interaction with the device. In some embodiments, a virtual click wheel is displayed on the touch screen of a portable multifunction device and operated by user contact with the touch screen.

Device 100 also includes a power system 162 for powering the various components. The power system 162 may include a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 may also include one or more optical sensors 164. FIG. 9 shows an optical sensor coupled to an optical sensor controller 158 in I/O subsystem 106. The optical sensor 164 may include charge-coupled device (CCD) or complementary metal-oxide semiconductor (CMOS) phototransistors. The optical sensor 164 receives light from the environment, projected through one or more lens, and converts the light to data representing an image. In conjunction with an imaging module 143 (also called a camera module), the optical sensor 164 may capture still images or video. In some embodiments, an optical sensor is located on the back of device 100, opposite the touch screen display 112 on the front of the device, so that the touch screen display may be used as a viewfinder for either still and/or video image acquisition. In some embodiments, an optical sensor is located on the front of the device so that the user's image may be obtained for videoconferencing while the user views the other video conference participants on the touch screen display. In some embodiments, the position of the optical sensor 164 can be changed by the user (e.g., by rotating the lens and the sensor in the device housing) so that a single optical sensor 164 may be used along with the touch screen display for both video conferencing and still and/or video image acquisition.

Device 100 may also include one or more proximity sensors 166. FIG. 4 shows a proximity sensor 166 coupled to the peripherals interface 118. Alternately, the proximity sensor 166 may be coupled to an input controller 160 in the I/O subsystem 106. The proximity sensor 166 may perform as described in U.S. patent application Ser. No. 11/241,839, “Proximity Detector In Handheld Device,” filed Sep. 30, 2005; Ser. No. 11/240,788, “Proximity Detector In Handheld Device,” filed Sep. 30, 2005; Ser. No. 11/620,702, “Using Ambient Light Sensor To Augment Proximity Sensor Output”; Ser. No. 11/586,862, “Automated Response To And Sensing Of User Activity In Portable Devices,” filed Oct. 24, 2006; and Ser. No. 11/638,251, “Methods And Systems For Automatic Configuration Of Peripherals,” which are hereby incorporated by reference in their entirety. In some embodiments, the proximity sensor turns off and disables the touch screen 112 when the multifunction device is placed near the user's ear (e.g., when the user is making a phone call). In some embodiments, the proximity sensor keeps the screen off when the device is in the user's pocket, purse, or other dark area to prevent unnecessary battery drainage when the device is a locked state.

Device 100 may also include one or more accelerometers 168. FIG. 4 shows an accelerometer 168 coupled to the peripherals interface 118. Alternately, the accelerometer 168 may be coupled to an input controller 160 in the I/O subsystem 106. The accelerometer 168 may perform as described in U.S. Patent Publication No. 2005/0190059, “Acceleration-based Theft Detection System for Portable Electronic Devices,” and U.S. Patent Publication No. 2006/0017692, “Methods And Apparatuses For Operating A Portable Device Based On An Accelerometer,” both of which are which are incorporated by reference in their entirety. In some embodiments, information is displayed on the touch screen display in a portrait view or a landscape view based on an analysis of data received from the one or more accelerometers.

In some embodiments, the software components stored in memory 102 may include an operating system 126, a communication module (or set of instructions) 128, a contact/motion module (or set of instructions) 130, a graphics module (or set of instructions) 132, a text input module (or set of instructions) 134, a Global Positioning System (GPS) module (or set of instructions) 135, and applications (or set of instructions) 136.

The operating system 126 (e.g., Android, RTXC, Linux, Unix, OS X, Windows, or an embedded operating system such as VxWorks) includes various software components and/or drivers for controlling and managing general system tasks (e.g., memory management, storage device control, power management, etc.) and facilitates communication between various hardware and software components.

The communication module 128 facilitates communication with other devices over one or more external ports 124 and also includes various software components for handling data received by the RF circuitry 108 and/or the external port 124. The external port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used on iPod (trademark of Apple Computer, Inc.) devices.

The contact/motion module 130 may detect contact with the touch screen 112 (in conjunction with the display controller 156) and other touch sensitive devices (e.g., a touchpad or physical click wheel). The contact/motion module 130 includes various software components for performing various operations related to detection of contact, such as determining if contact has occurred, determining if there is movement of the contact and tracking the movement across the touch screen 112, and determining if the contact has been broken (i.e., if the contact has ceased). Determining movement of the point of contact may include determining speed (magnitude), velocity (magnitude and direction), and/or an acceleration (a change in magnitude and/or direction) of the point of contact. These operations may be applied to single contacts (e.g., one finger contacts) or to multiple simultaneous contacts (e.g., “multitouch”/multiple finger contacts). In some embodiments, the contact/motion module 130 and the display controller 156 also detects contact on a touchpad. In some embodiments, the contact/motion module 130 and the controller 160 detects contact on a click wheel.

The graphics module 132 includes various known software components for rendering and displaying graphics on the touch screen 112, including components for changing the intensity of graphics that are displayed. As used herein, the term “graphics” includes any object that can be displayed to a user, including without limitation text, web pages, icons (such as user-interface objects including soft keys), digital images, videos, animations and the like. An animation in this context is a display of a sequence of images that gives the appearance of movement, and informs the user of an action that has been performed (such as moving an email message to a folder). In this context, a respective animation that confirms an action by the user of the device typically takes a predefined, finite amount of time, such as an amount of time between 0.2 and 1.0 seconds, or between 0.5 and 2.0 seconds, depending on the context.

The text input module 134, which may be a component of graphics module 132, provides soft keyboards for entering text in various applications (e.g., contacts 137, e-mail 140, IM 141, blogging 142, browser 147, and any other application that needs text input).

The GPS module 135 determines the location of the device and provides this information for use in various applications (e.g., to telephone 138 for use in location-based dialing, to camera 143 and/or blogger 142 as picture/video metadata, and to applications that provide location-based services such as weather widgets, local yellow page widgets, and map/navigation widgets).

The applications 136 may include the following modules (or sets of instructions), or a subset or superset thereof:

a contacts module 137 (sometimes called an address book or contact list); a telephone module 138;

a video conferencing module 139;

an e-mail client module 140;

an instant messaging (IM) module 141;

a blogging module 142;

a camera module 143 for still and/or video images;

an image management module 144;

a video player module 145;

a music player module 146;

a browser module 147;

a calendar module 148;

widget modules 149, which may include weather widget 149a, stocks widget 149b, calculator widget 149c, alarm clock widget 149d, dictionary widget 149e, and other widgets obtained by the user, as well as user-created widgets 149f;

widget creator module 150 for making user-created widgets 149f;

search module 151;

video and music player module 152, which merges video player module 145 and music player module 146;

notes module 153; and/or

map module 154.

Examples of other applications 136 that may be stored in memory 102 include other word processing applications, JAVA-enabled applications, encryption, digital rights management, voice recognition, and voice replication.

In conjunction with touch screen 112, display controller 156, contact module 130, graphics module 132, and text input module 134, the contacts module 137 may be used to manage an address book or contact list, including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference 139, e-mail 140, or IM 141; and so forth. Embodiments of user interfaces and associated processes using contacts module 137 are described further below.

In conjunction with RF circuitry 108, audio circuitry 110, speaker 111, microphone 113, touch screen 112, display controller 156, contact module 130, graphics module 132, and text input module 134, the telephone module 138 may be used to enter a sequence of characters corresponding to a telephone number, access one or more telephone numbers in the address book 137, modify a telephone number that has been entered, dial a respective telephone number, conduct a conversation and disconnect or hang up when the conversation is completed. As noted above, the wireless communication may use any of a plurality of communications standards, protocols and technologies. Embodiments of user interfaces and associated processes using telephone module 138 are described further below.

In conjunction with RF circuitry 108, audio circuitry 110, speaker 111, microphone 113, touch screen 112, display controller 156, optical sensor 164, optical sensor controller 158, contact module 130, graphics module 132, text input module 134, contact list 137, and telephone module 138, the videoconferencing module 139 may be used to initiate, conduct, and terminate a video conference between a user and one or more other participants.

In conjunction with RF circuitry 108, touch screen 112, display controller 156, contact module 130, graphics module 132, and text input module 134, the e-mail client module 140 may be used to create, send, receive, and manage e-mail. In conjunction with image management module 144, the e-mail module 140 makes it very easy to create and send e-mails with still or video images taken with camera module 143. Embodiments of user interfaces and associated processes using e-mail module 140 are described further below.

In conjunction with RF circuitry 108, touch screen 112, display controller 156, contact module 130, graphics module 132, and text input module 134, the instant messaging module 141 may be used to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages and to view received instant messages. In some embodiments, transmitted and/or received instant messages may include graphics, photos, audio files, video files and/or other attachments as are supported in a MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS). Embodiments of user interfaces and associated processes using instant messaging module 141 are described further below.

In conjunction with RF circuitry 108, touch screen 112, display controller 156, contact module 130, graphics module 132, text input module 134, image management module 144, and browsing module 147, the blogging module 142 may be used to send text, still images, video, and/or other graphics to a blog (e.g., the user's blog).

In conjunction with touch screen 112, display controller 156, optical sensor(s) 164, optical sensor controller 158, contact module 130, graphics module 132, and image management module 144, the camera module 143 may be used to capture still images or video (including a video stream) and store them into memory 102, modify characteristics of a still image or video, or delete a still image or video from memory 102. Embodiments of user interfaces and associated processes using camera module 143 are described further below.

In conjunction with touch screen 112, display controller 156, contact module 130, graphics module 132, text input module 134, and camera module 143, the image management module 144 may be used to arrange, modify or otherwise manipulate, label, delete, present (e.g., in a digital slide show or album), and store still and/or video images. Embodiments of user interfaces and associated processes using image management module 144 are described further below.

In conjunction with touch screen 112, display controller 156, contact module 130, graphics module 132, audio circuitry 110, and speaker 111, the video player module 145 may be used to display, present or otherwise play back videos (e.g., on the touch screen or on an external, connected display via external port 124). Embodiments of user interfaces and associated processes using video player module 145 are described further below.

In conjunction with touch screen 112, display system controller 156, contact module 130, graphics module 132, audio circuitry 110, speaker 111, RF circuitry 108, and browser module 147, the music player module 146 allows the user to download and play back recorded music and other sound files stored in one or more file formats, such as MP3 or AAC files. In some embodiments, device 100 may include the functionality of an MP3 player, such as an iPod (trademark of Apple Computer, Inc.). Embodiments of user interfaces and associated processes using music player module 146 are described further below.

In conjunction with RF circuitry 108, touch screen 112, display system controller 156, contact module 130, graphics module 132, and text input module 134, the browser module 147 may be used to browse the Internet, including searching, linking to, receiving, and displaying web pages or portions thereof, as well as attachments and other files linked to web pages. Embodiments of user interfaces and associated processes using browser module 147 are described further below.

In conjunction with RF circuitry 108, touch screen 112, display system controller 156, contact module 130, graphics module 132, text input module 134, e-mail module 140, and browser module 147, the calendar module 148 may be used to create, display, modify, and store calendars and data associated with calendars (e.g., calendar entries, to do lists, etc.). Embodiments of user interfaces and associated processes using calendar module 148 are described further below.

In conjunction with RF circuitry 108, touch screen 112, display system controller 156, contact module 130, graphics module 132, text input module 134, and browser module 147, the widget modules 149 are mini-applications that may be downloaded and used by a user (e.g., weather widget 149a, stocks widget 149b, calculator widget 149c, alarm clock widget 149d, and dictionary widget 149e) or created by the user (e.g., user-created widget 1491). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display system controller 156, contact module 130, graphics module 132, text input module 134, and browser module 147, the widget creator module 150 may be used by a user to create widgets (e.g., turning a user-specified portion of a web page into a widget).

In conjunction with touch screen 112, display system controller 156, contact module 130, graphics module 132, and text input module 134, the search module 151 may be used to search for text, music, sound, image, video, and/or other files in memory 102 that match one or more search criteria (e.g., one or more user-specified search terms).

In conjunction with touch screen 112, display controller 156, contact module 130, graphics module 132, and text input module 134, the notes module 153 may be used to create and manage notes, to do lists, and the like.

In conjunction with RF circuitry 108, touch screen 112, display system controller 156, contact module 130, graphics module 132, text input module 134, GPS module 135, and browser module 147, the map module 154 may be used to receive, display, modify, and store maps and data associated with maps (e.g., driving directions; data on stores and other points of interest at or near a particular location; and other location-based data).

Each of the above identified modules and applications correspond to a set of instructions for performing one or more functions described above. These modules (i.e., sets of instructions) need not be implemented as separate software programs, procedures or modules, and thus various subsets of these modules may be combined or otherwise re-arranged in various embodiments. For example, video player module 145 may be combined with music player module 146 into a single module (e.g., video and music player module 152). In some embodiments, memory 102 may store a subset of the modules and data structures identified above. Furthermore, memory 102 may store additional modules and data structures not described above.

In some embodiments, device 100 is a device where operation of a predefined set of functions on the device is performed exclusively through a touch screen 112 and/or a touchpad. By using a touch screen and/or a touchpad as the primary input/control device for operation of device 100, the number of physical input/control devices (such as push buttons, dials, and the like) on device 100 may be reduced.

The predefined set of functions that may be performed exclusively through a touch screen and/or a touchpad include navigation between user interfaces. In some embodiments, the touchpad, when touched by the user, navigates device 100 to a main, home, or root menu from any user interface that may be displayed on device 100. In such embodiments, the touchpad may be referred to as a “menu button.” In some other embodiments, the menu button may be a physical push button or other physical input/control device instead of a touchpad.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a hardware processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the description and claims of the application, each of the words “comprise” “include” and “have”, and forms thereof, are not necessarily limited to members in a list with which the words may be associated. In addition, where there are inconsistencies between this application and any document incorporated by reference, it is hereby intended that the present application controls.

What is claimed is:

1. A method,
wherein the method is for mobile advertising, comprising:
transmitting, by an acoustic tag, a pre-determined acoustic signal associated with the acoustic tag, using a first software program executed on the acoustic tag,
wherein the first software program is stored in a first non-transitory computer-readable storage medium of the acoustic tag,
wherein the acoustic tag has a first hardware processor that executes the first software program, and
wherein the first hardware processor, when executing the first software program, emits the acoustic signal associated with the acoustic tag through an acoustic transducer,
initiating, by a handheld electronic device, a monitoring of ambient sound for the emitted acoustic signal associated with the acoustic tag, using a second software program executed on the handheld electronic device,
wherein the second software program is stored in a second non-transitory computer-readable storage medium of the handheld electronic device, and
wherein the ambient sound is acquired via a microphone on the handheld electronic device, and converted to an electrical signal that corresponds to the ambient sound acquired by the microphone,
transmitting the electrical signal that corresponds to the ambient sound to a second hardware processor specifically programmed to analyze the electrical signal that corresponds to the ambient sound for the presence of the emitted specific acoustic signal associated with the acoustic tag,
wherein the second hardware processor executes a third software program being stored in a third non-transitory computer-readable storage medium, and
wherein the second hardware processor, when executing the third software program, performs at least the following steps:
1. converting the electrical signal that corresponds to the ambient sound from a time-domain type signal to a frequency-domain type signal based at least in part, on at least one fast Fourier transform (FFT) algorithm;
2. comparing the resulting frequency-domain type signal to a plurality of entries in at least one lookup table wherein each entry corresponds to at least one acoustic signal associated with at least one acoustic tag;
3. based on the comparing, determining, in the ambient sound, a particular acoustic signal associated with a particular acoustic tag; and
4. based on the determining, transmitting at least one notification confirming the presence of the particular acoustic tag; and
based on the at least one notification, triggering, by the handheld electronic device, presenting at least one advertisement message, wherein the at least one advertisement message is specifically pre-determined for the presence of the particular acoustic signal associated with the particular acoustic tag.

2. The method of claim 1, wherein the presenting is on a display of the handheld electronic device.

3. The method of claim 1, wherein the monitoring of the ambient sound is initiated when the handheld electronic device is in a pre-determined location.

4. The method of claim 3, wherein the monitoring of the ambient sound is initiated when the handheld electronic device is in proximity to the particular acoustic tag.

5. The method of claim 3, wherein the handheld electronic device is further comprises a location module,
wherein the location module is selected from the group consisting of: a global positioning system (GPS) hardware module, a cellular multilateration software module and a Wi-Fi-based positioning system (WPS) software module.

6. The method of claim 1, wherein the at least one advertisement message associated with the acoustic tag is stored on a server containing a plurality of advertisement messages.

7. The method of claim 6, wherein the triggering by the handheld device include communicating with the server to retrieve the at least one advertisement message associated with the acoustic tag from the plurality of advertisement messages.

8. The method of claim 1, wherein the pre-determined acoustic signal is encoded and executed by an oscillator chip.

9. A computing advertisement system, comprising:
a first software program is stored in a first non-transitory computer-readable storage medium,
a first hardware processor, when executing the first software program, is configured to at least perform:
1. receiving the electrical signal that corresponds to an ambient sound;
2. converting the electrical signal that corresponds to the ambient sound from a time-domain type signal to a frequency-domain type signal based at least in part, on at least one fast Fourier transform (FFT) algorithm;
3. comparing the resulting frequency-domain type signal to a plurality of entries in at least one lookup table wherein each entry corresponds to at least one acoustic signal associated with at least one acoustic tag;
4. based on the comparing, determining, in the ambient sound, a particular acoustic signal associated with a particular acoustic tag;
5. based on the determining, transmitting at least one notification confirming the presence of the particular acoustic tag;
6. based on the at least one notification, causing to trigger, by a handheld electronic device, presenting at least one advertisement message, wherein the at least one advertisement message is specifically pre-determined for the presence of the particular acoustic signal associated with the particular acoustic tag;
wherein the electrical signal is generated, by a handheld electronic device, when the handheld electronic device:
monitors the ambient sound for an emitted acoustic signal associated with an acoustic tag, using a second software program executed on the handheld electronic device, wherein the second software program is stored in a second non-transitory computer-readable storage medium of the handheld electronic device; and
acquires the ambient sound via a microphone on the handheld electronic device; and
wherein the emitted acoustic signal is emitted by an acoustic tag, comprising:
a third software program is stored in a third non-transitory computer-readable storage medium,
a third hardware processor, when executing the third software program, is configured to at least perform:
transmit a trigger signal,
an acoustic transducer that emits an acoustic signal that is associated with the acoustic tag, when the trigger signal is received, and
a power supply.

10. The acoustic tag of claim 9, wherein the power supply is configured to power-down the acoustic tag under certain conditions.

11. The acoustic tag of claim 9, wherein the acoustic tag configured to be attached to an object.
